(19) United States
(12) Patent Application Publication
(10) Pub. No.: US 2008/0269062 A1
(43) Pub. Date: Oct. 30, 2008

(54) BANDPASS FILTER AND FORMING METHOD OF THE SAME

(75) Inventors: Masatoshi ISHII, Kawasaki (JP); Kazunori YAMANAKA, Kawasaki (JP); John D. BANIECKI, Kawasaki (JP); Akihiko AKASEGAWA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/106,482

(22) Filed: Apr. 21, 2008

(30) Foreign Application Priority Data
Apr. 27, 2007 (JP) 2007-119710

(51) Int. Cl. H01P 1/20; H01P 11/00

(52) U.S. Cl. 505/210; 333/99 S; 333/208; 29/600

(57) ABSTRACT

A bandpass filter capable of creating a dual mode with a simple configuration and stably adjusting the filter characteristics of the bandpass filter is disclosed. The bandpass filter includes a dielectric base substrate; a disk resonator formed over the dielectric base substrate; and a dielectric block disposed over a part of the dielectric base substrate and in substantially the same plane as the disk resonator.

### CROSS-REFERENCE TO RELATED APPLICATION

The present application is based on Japanese Priority Application No. 2007-119710 filed on Apr. 27, 2007, the entire contents of which are hereby incorporated by reference.

### BACKGROUND

1. Field

The present invention generally relates to high-frequency circuit elements used in, for example, the wireless communication field, and more particularly to a structure of a bandpass filter using a resonator for passing only a desired frequency and a manufacturing method of the bandpass filter.

2. Description of the Related art

Recently, with prevalence and development of cell phones, fast and high-capacity transmission technologies have become indispensable. To realize such a fast and high-capacity transmission technology, a wide frequency range is required to be secured. Therefore, the frequency range used in wireless communications is being shifted to a higher frequency range. Accordingly, as a filter used in a base station of a mobile communication system, a bandpass filter capable of effectively passing a desired frequency in a high frequency range is necessary. In such circumstances, a superconductor is a promising material for a filter used in a base station for a mobile communication system because the surface resistance of a superconductor is much less than that of a general good conductor even in a high frequency range, thereby a low-loss resonator having a high Q value is expected.

When a superconductor is used as a transmission filter in a transmission frontend, it is suggested that a circular (disk-shaped) resonator pattern be used instead of a strip-type resonator pattern so as to control the increase of current loss by an input of high RF power. This is because when a circular pattern is used, it is possible to control the concentration of current density that is likely to be generated at an edge and a corner part of a microstrip line.

When a signal is applied to a disk resonator and a signal corresponding to the resonance frequency is taken, a steeper filter characteristic can be obtained by arranging input and output ports (signal input and output lines) at orthogonal positions with respect to the resonator so as to create a dual mode compared with a case where the input and output ports are arranged at 180 degrees with respect to the resonator. When a notch is formed on a disk resonator it is possible to operate the resonator in a dual mode. However, there is a problem that the concentration of the current into the notch part is increased, thereby lowering the withstand power characteristics of the filter.

To solve the problem, a method of controlling the concentration of current by forming a circular (arch-shaped) notch on a disk resonator (see, for example, Patent Document 1), and a method of avoiding the current concentration and creating a dual mode by displacing a dielectric unit on a disk resonator where a conductor pattern is formed on the dielectric unit (see, for example, Patent Document 2) are proposed.

Patent Document 1: Japanese Patent Application Publication No. 2006-101187

Patent Document 2: Japanese Patent Application Publication No. 2006-115416

In the method of Patent Document 2, the dielectric unit is preferably required to be on the upper surface of the dielectric unit. Furthermore, there is a problem that if there were even a small gap between the dielectric unit and the disk-shaped resonator pattern the filter characteristics would be changed, thereby complicating the adjustment.

### SUMMARY

According to an aspect of the present invention, there is provided a bandpass filter including a dielectric base substrate; a disk resonator formed over the dielectric base substrate; and a dielectric block disposed over a part of the dielectric base substrate and in substantially the same plane as the disk resonator.

According to another aspect of the present invention, there is provided a method of forming a bandpass filter. The method includes

(a) forming an disk resonator and input and output signal lines over a dielectric base substrate, the input and the output signal lines extending at substantially 90 degrees from each other with respect to the disk resonator; and

(b) disposing a dielectric block at a position other than a position that is opposite to the input port and the output port with respect to a center of the disk resonator and that is on an extended line passing though the center of the disk resonator and the input port or on an extended line passing though the center of the disk resonator and the output port, the dielectric block having a size to cover a part of the dielectric base substrate.

### BRIEF DESCRIPTION OF THE DRAWINGS

Other objects, features, and advantages of the present invention will become more apparent from the following description when read in conjunction with the accompanying drawings, in which:

FIGS. 1A and 1B are drawings schematically showing a configuration of bandpass filter according to an embodiment of the present invention;

FIGS. 2A and 2B are drawings each schematically showing an example where the bandpass filter in FIG. 1 is practically implemented;

FIG. 3 is a graph showing a filter characteristic of a bandpass filter according to an embodiment of the present invention including a dielectric block compared with a filter characteristic of a bandpass filter having no dielectric block;

FIG. 4 is a drawing showing mutual positions of a disk resonator and the dielectric block;

FIG. 5 is a graph showing relationship between the position of the dielectric block and the filter characteristics;

FIG. 6 is a graph showing relationships between the film thickness of the dielectric block and the filter characteristics;

FIG. 7 is a graph showing relationships between the permittivity of the dielectric block and the filter characteristics;

FIG. 8 is a graph showing relationships between the size of the dielectric block and the filter characteristics; and

FIG. 9 is a graph showing relationships between the shape of the dielectric block and the filter characteristics.

### DETAILED DESCRIPTION OF THE INVENTION

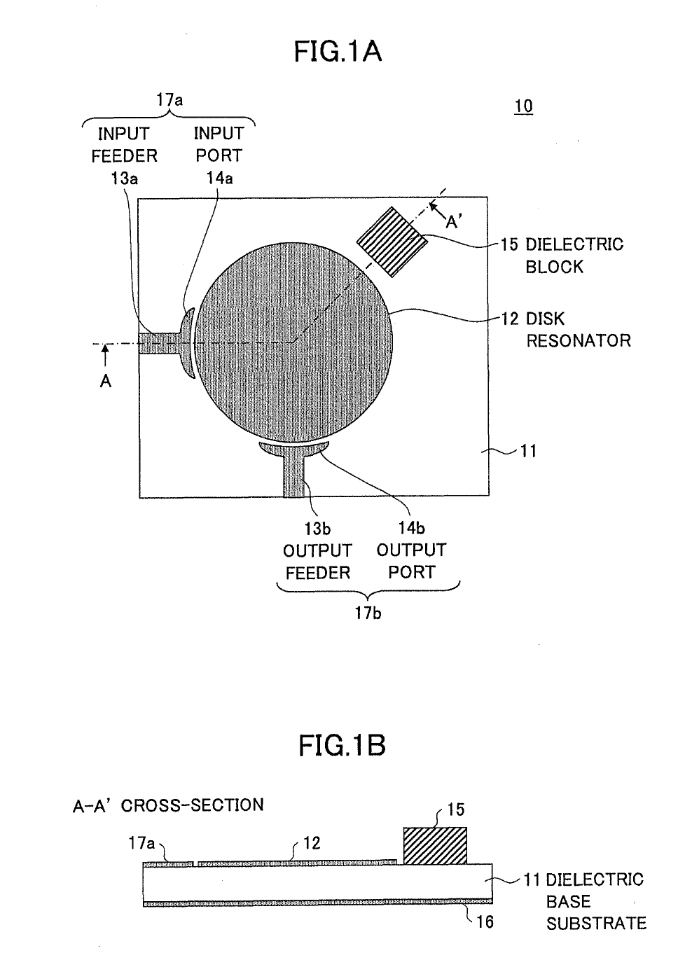

In the following, an exemplary embodiment of the present invention is described with reference to the accompanying drawings. FIGS. 1A and 1B are a plan view and a side view, respectively, of a bandpass filter 10 according to an embodiment of the present invention. The bandpass filter 10 includes a dielectric base substrate 11, a disk resonator 12 disposed on the dielectric substrate 11, an input port 14a and an output port 14b disposed at 90 degrees relative to each other and with respect to the disk resonator 12, an input feeder 13a and an output feeder 13b connected to the input port 14a and the output port 14b, respectively, and a dielectric block 15 disposed only on a part of an upper surface of the dielectric base substrate 11. The cross-sectional shapes of the input port 14a and the output port 14b expand like a trumpet approaching the disk resonator 12 and face the disk resonator 12 so as to be electromagnetically connected to the disk resonator 12. The input feeder 13a and the input port 14a constitute an input signal line 17a, and the output feeder 13b and the output port 14b constitute an output signal line 17b. The disk resonator 12 and the input and output signal lines 17a and 17b are made of, for example, a superconducting material, but may be formed of a good conductor material.

The dielectric base substrate 11 is, for example, an MgO substrate having a ground film 16 formed on the entire rear surface of the MgO substrate.

The dielectric block 15 disposed on a part of the upper surface of the dielectric base substrate 11 is, for example, an STO (SrTiO₃) block.

To form a bandpass filter as described above, for example, YBCO thin films (the composition formula is YBa₂Cu₃O₆₊ₓ) having a film thickness of 500 nm are formed on both sides of the MgO (100) substrate having a thickness of 0.5 mm by, for example, a Pulsed Laser Deposition (PLD) method. One of the formed YBCO thin films is used as the ground film 16. On the other YBCO thin film, a resist film (not shown) having a prescribed patterns is formed utilizing photolithography technique, and the YBCO film patterns having the shapes of the disk resonator 12 and the input and output signal lines 17a and 17b are formed by Ar milling (dry etching). Then the resist film is removed using a remover. When a bandpass filter of, for example, 5 GHz band is formed, the diameter of the disk resonator should be 11 mm. The distance between the ends of the input and output ports 14a and 14b and the disk resonator 12 is, for example, 100 μm.

On the other hand, an STO (100) substrate having a thickness of 0.5 mm is cut into a 2.1 mm block to form the STO block 15. The STO block 15 is disposed at 45 degrees rotated from the extended lines of the input and the output feeders 13a and 13b, respectively, and near the circumference of the disk resonator 12. In the configuration of FIG. 1, the STO block 15 is disposed slightly outward from the disk resonator 12. However, in an example described below, the STO block 15 is displaced so as to overlap with the disk resonator 12 by 0.1 mm.

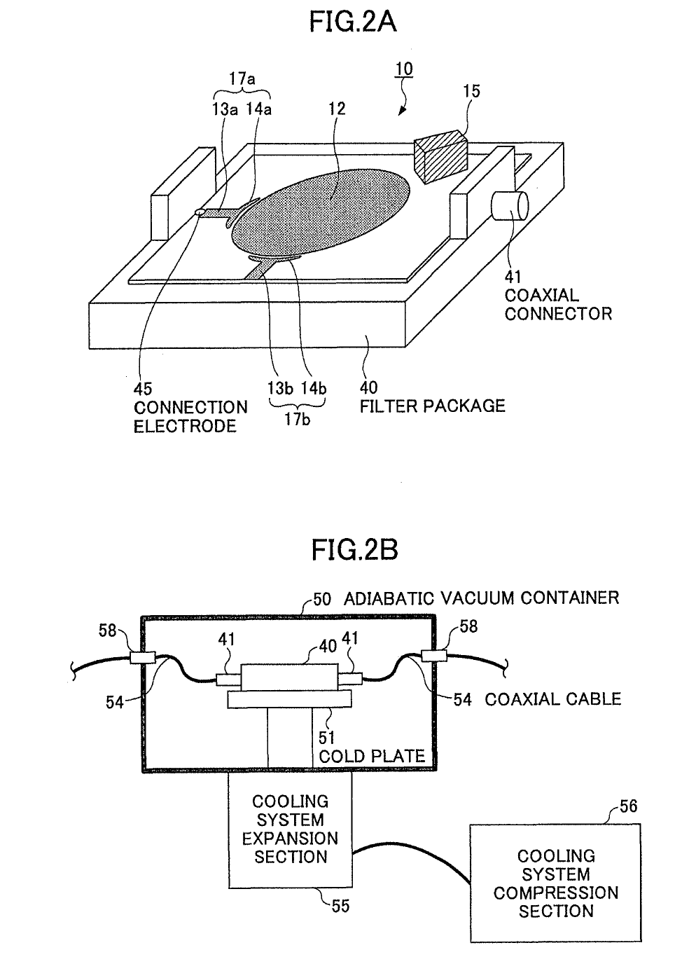

FIGS. 2A and 2B show an example where a bandpass filter of FIG. 1 is implemented. FIG. 2A is a perspective view of the bandpass filter contained in a package. FIG. 2B is a drawing schematically showing the package disposed in an adiabatic vacuum container of a cooling system.

As shown in FIG. 2A, the bandpass filter 10 is housed in a filter package 40. Each of connection electrodes 45 connected to the input and the output feeders 13a and 13b is connected to a center conducting part (not shown) of corresponding coaxial connector 41. The filter package 40 is, for example, a copper-shielded case with gilded surfaces. In this case, any method of connecting the connection electrode 45 to the corresponding center conducting part of the corresponding coaxial connector 41, including wirebonding by ultrasonic thermal compression bonding, tape bonding, and soldering may be used. After the connection between the coaxial cables 41 and the corresponding connection electrodes 45 are completed, the filter package 40 is covered with a package cover (not shown) to be hermetically sealed. A signal to be filtered is input into the bandpass filter via a coaxial cable connected to the coaxial connector 41 (see FIG. 2B). The filtered output signal is output to the coaxial cable on the output side.

When the resonator 12 of a bandpass filter is formed of a superconducting material, the bandpass filter in the package is to be housed in a cooling system as shown in FIG. 2B. More specifically, the package is disposed on a cold plate 51 in an adiabatic vacuum container 50, and after being evacuated to 10 to 3 Pa, the air is cooled to a prescribed temperature of, for example, 70 K. The air is cooled by using a cooling system expansion section 55 and a cooling system compression section 56 together.

Each of the coaxial connectors 42 on the package 40 is connected to the corresponding hermetic coaxial connector 58 on the adiabatic vacuum container 50 to input and output signals from and to, respectively, the outside of the adiabatic vacuum container 50.

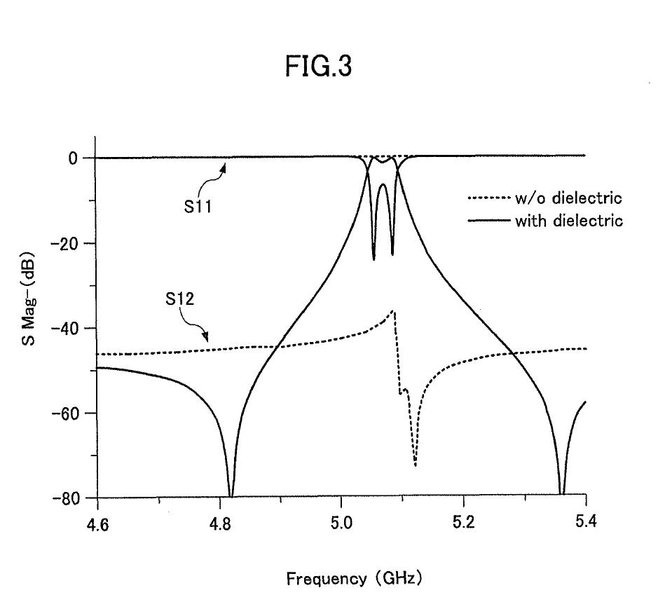

FIG. 3 is a graph showing an electromagnetic simulation result of a bandpass filter configured as described above. The dotted lines in FIG. 3 show the S11 and S21 characteristics when there is no STO block 50. On the other hand, the full lines in FIG. 3 show the S11 and S12 characteristics when the STO block 15 is disposed so as to partially overlap with the circumference of the disk resonator 12.

As shown in FIG. 3, without the STO block 15, there is no connection between the input and the output. However, when the STO block is disposed as described above, a dual mode is created and good characteristics of the bandpass filter are obtained.

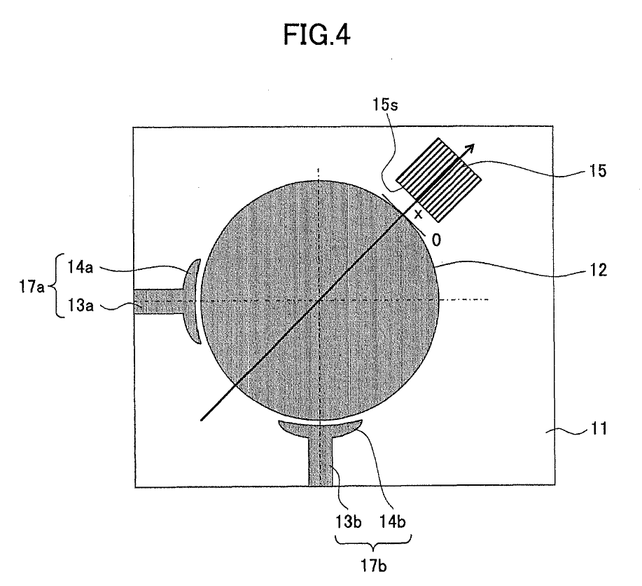

Next, the relationship between the shape and the position of the dielectric block 15 is described. FIG. 4 shows the positions of the disk resonator 12 and the dielectric block 15. As shown in FIG. 4, each straight center line extending in the longitudinal direction of input and output feeders is extended through the disk resonator 12. The two extended center lines of the input and output feeders cross at the center of the disk resonator 12. Next, the other straight line extending though the center of the dielectric block 15 also crosses the other two lines at the center of the disk resonator 12. In FIG. 4, the dielectric block 15 is disposed so that the angle between the straight line passing though the dielectric block 15 and each of the straight lines passing through the input and the output feeders 13a and 13b is 45 degrees. Then the dielectric block 15 is moved on the straight line passing through the center of the dielectric block 15, that is, in the radial direction of the disk resonator 12. As shown in FIG. 4, a tangent line passing through the intersection between the circumference of the disk resonator 12 and the straight line extended from the dielectric block 15 is drawn. The distance between the tangent line and an end surface 15s of the dielectric block 15 is changed. The end surface 15s faces the disk resonator 12. As shown in FIG. 4, it is assumed that when the end surface 15s is on the tangent line, the distance is “0”. While the distance is changed, the characteristic at each point is measured. The distance has a positive value when the surface 15s is separated from the tangent line. On the other hand, the distance has a negative value when the surface 15s passes the tangent line, enters into, and overlaps the disk resonator 12.

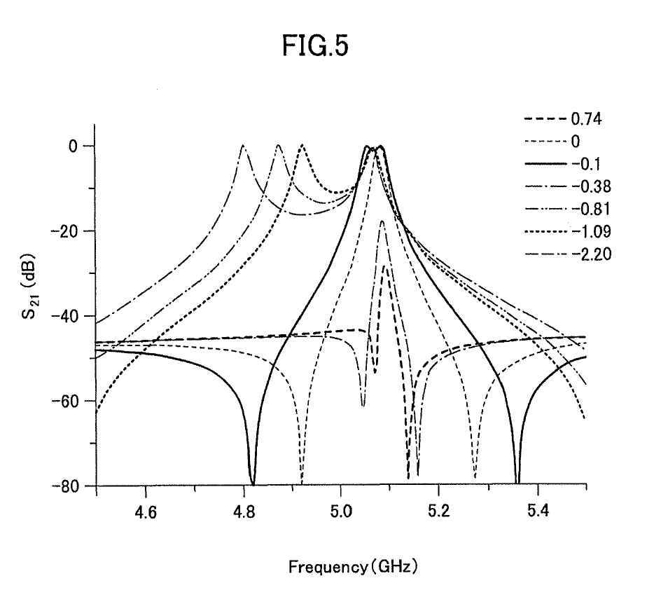

FIG. 5 is graph showing relationships between the position of the dielectric block 15 and the filter characteristics. In the graph, the end surface 15s of the dielectric block 15 is moved from the position 0.74 mm separated outward from the edge part of the disk resonator 12 through the position on the tangent line (distance=0 mm) and inside the disk resonator 12 to gradually increase the overlap distance. According to the results of this movement, when the position of the dielectric block 15 is moved, one of the resonant frequencies can be shifted to a lower frequency range while the other resonant frequency is unchanged. Therefore, a desired dual-mode filter can be obtained by controlling the position of the dielectric block 15 in the design stage. For example, when the overlap distance is −0.1 mm (namely, the dielectric block 15 overlaps 0.1 mm inside the disk resonator 12), flat characteristics of approximately −1 dB in the band are obtained.

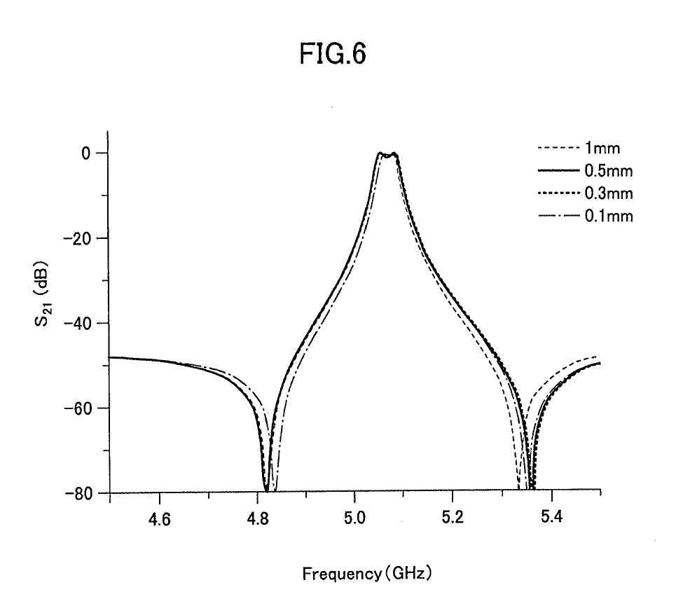

FIG. 6 is a graph showing relationships between the film thickness of the dielectric block 15 and the filter characteristics. As shown in FIG. 6, the film thickness of the dielectric block 15 is changed from 1 mm to 0.1 mm. Though only a slight change is observed when the film thickness is 0.1 mm, the filter characteristics can only be slightly changed even when the film thickness of the dielectric block 15 is changed. Namely, the thickness of the dielectric block 15 on the dielectric base substrate 11 does not have much influence on the filter characteristics.

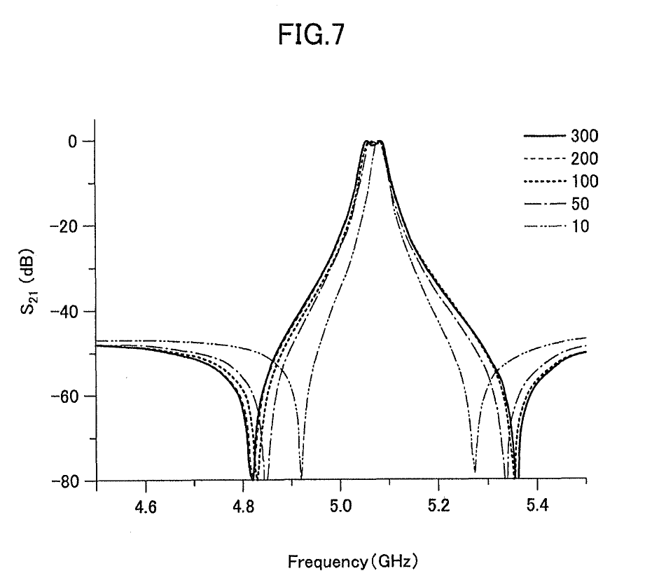

FIG. 7 is a graph showing relationships between the permittivity of the dielectric block 15 and the filter characteristics. During this measurement, the distance of the dielectric block 15 is fixed at −0.1 mm inside the disk resonator 12 (that is, the dielectric block 15 overlaps the disk resonator 12 by 0.1 mm). Then, when the permittivity of the dielectric block 15 is changed from 300 to 10, there are only slight changes on the bandwidth and the center frequency. However, the change has little influence on creating the dual mode. Namely, creating the dual mode has little dependence on the permittivity of the dielectric block 15, and the dual mode can be created by the dielectric block 15 having a permittivity between 300 and 100.

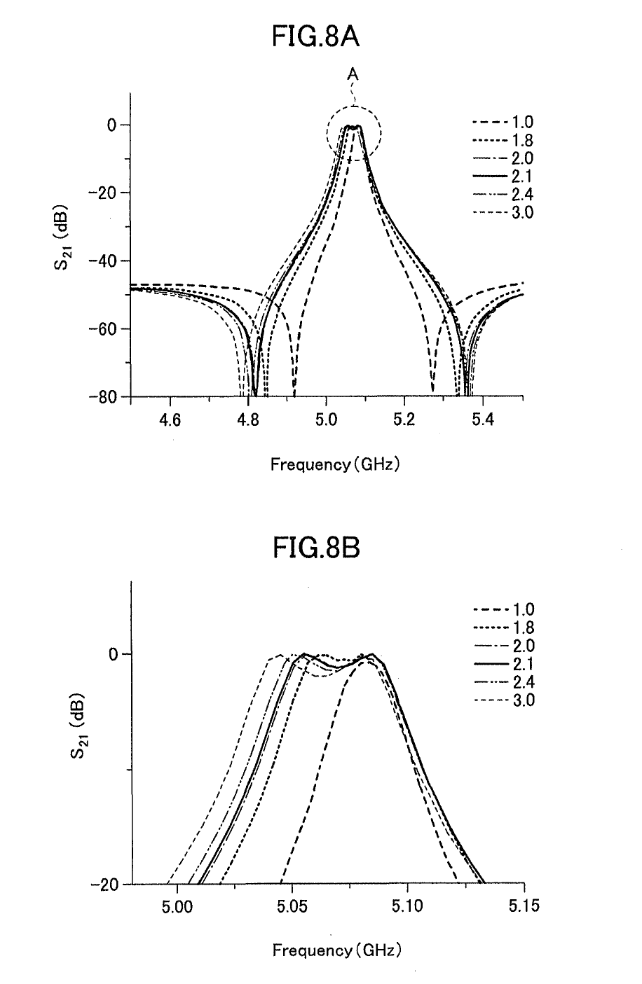

FIGS. 8A and 8B are graphs showing relationships between the size of the dielectric block 15 and the filter characteristics. During the measurement, the thickness of the dielectric block 15 and the distance of the dielectric block 15 are fixed at 0.5 mm and −0.1 mm, respectively. Then, the size of the dielectric block 15 is changed from (1.0 mm)×(1.0 mm) to (3.0 mm)×(3.0 mm), and the obtained filter characteristics are shown in FIG. 8A. FIG. 8B is an enlarged view of an circled area “A” in FIG. 8A. As shown especially in FIG. 8B, as the size of the dielectric block 15 becomes larger, a coupling becomes stronger. Namely, the coupling coefficient of a dual mode can be adjusted by changing the size of the dielectric block 15.

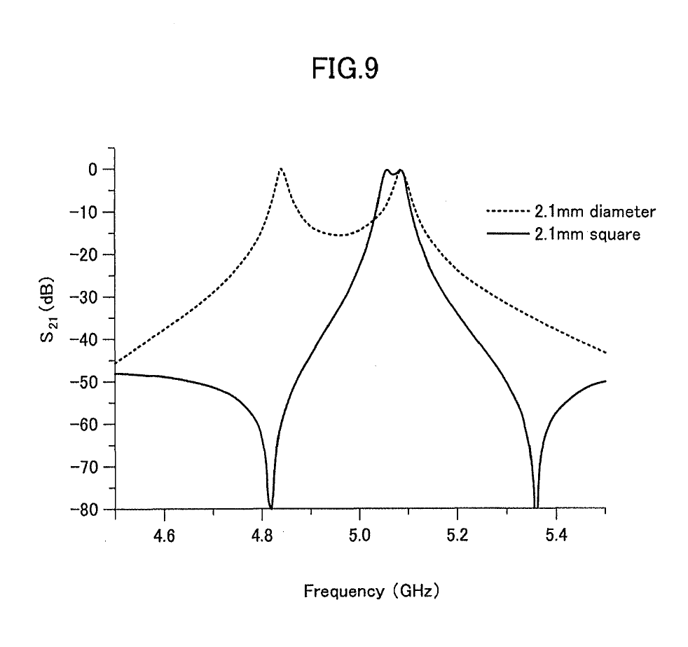

FIG. 9 is a graph showing relationships between a shape of the dielectric block 15 and the filter characteristics. The dotted line shows filter characteristics of the dielectric block 15 having a circular shape (diameter: 2.1 mm) in plan view. On the other hand, the solid line shows filter characteristics of the dielectric block 15 having a square shape (each side: 2.1 mm) in plan view. As FIG. 9 shows, as regarding the dielectric block 15, a square block has better filter characteristics than a circular block.

From the above results, the thickness and the permittivity of the dielectric block 15 do not have much effect on creating a dual mode (strength of coupling). However, by changing the position, the size, and the shape of the dielectric block 15, the coupling coefficient of a dual mode can be desirably adjusted.

Especially, a bandpass filter for the 5 GHz band having a dual mode and good frequency cut-off characteristics can be obtained when the diameter of the disk resonator 12 is 10 mm; the center lines of the input and the output ports 14a and 14b cross at 90 degrees; and the dielectric block 15 has permittivity between 50 and 300, the film thickness between 0.1 mm and 1 mm, length of each side between 2.0 mm and 2.4 mm, and overlaps the disk resonator 12.

In the above embodiment, the dielectric block 15 is disposed so that the center line of the dielectric block passing through the center of the disk resonator 12 has an angle of 45 degrees with respect to each of the center lines of the input and the output feeders 13a and 13b, respectively. However, an embodiment of the present invention is not limited to this case. More specifically, the dielectric block 15 may be disposed at any position other than positions on the center lines of the input and the output feeders 13a and 13b, respectively including the opposite positions of the input and the output ports 14a and 14b with respect to the disk resonator 12.

Further, in the above embodiment, STO (SrTiO₃) is used as the material of the dielectric block 15. However, in an embodiment of the present invention, the dielectric block 15 is not limited to STO. For example, TiO₂, CaTiO₃, (Ba, Sr)TiO₃, (called “BST”), and Bi_{1.5}Zn₁Nb_{1.5}O₇ (called “BNZ”) may be preferably used.

Still further, as the disk resonator 12, instead of using YBa₂Cu₃O₆₊ₓ, RBCO (R—Ba—Cu—O: as “R” element, Nd, Gd, Sm, or Ho is used), BSCCO(Bi—Sr—Ca—Cu—O), PBSCCO (Pb—Bi—Sr—Ca—Cu—O), and CBCCO(Cu—Baₚ—Ca_{q}—Cuᵣ—Oₓ) 1.5<ₚ<2.5, 2.5<_{q}<3.5, 3.5<ᵣ<4.5) may be used.

The present invention is not limited to the above exemplary embodiments, and variations and modifications may be made without departing from the scope of the present invention. Further, the present invention should not be interpreted to be limited by the description and accompanying drawings.

What is claimed is:

1. A bandpass filter comprising:
a dielectric base substrate;
a disk resonator formed over the dielectric base substrate; and
a dielectric block disposed over a part of the dielectric base substrate and in substantially the same plane as the disk resonator.

2. The bandpass filter according to claim 1, further comprising:
an input port and an output port disposed substantially at 90 degrees from each other with respect to the disk resonator and electromagnetically connected to the disk resonator.

3. The bandpass filter according to claim 2, wherein
the dielectric block is disposed at a position other than a position that is opposite to the input port and the output port with respect to a center of the disk resonator and that is on an extended line passing though the center of the disk resonator and the input port or on an extended line passing though the center of the disk resonator and the output port.

4. The bandpass filter according to claim 1, wherein
the dielectric block is disposed so as to partially overlap the disk resonator.

5. The bandpass filter according to claim 1, wherein
a film thickness of the dielectric block is between 0.1 mm and 1.0 mm.

6. The bandpass filter according to claim 1, wherein
a shape of the dielectric block is substantially a square.

7. The bandpass filter according to claim 1, wherein
the dielectric block is consisted of any one of SrTiO₃, TiO₂, CaTiO₃, (Ba, Sr)TiO₃, and Bi_{1.5}Zn₁Nb_{1.5}O₇.

8. The bandpass filter according to claim 1, wherein
the disk resonator is consisted of superconducting material.

9. The bandpass filter according to claim 2, wherein, further comprising:
an input feeder and an output feeder connected to the input port and the output port, respectively, wherein
the bandpass filter is housed in a package so that the input feeder and the output feeder are connected to the outside via corresponding coaxial connectors.

10. A method of forming a bandpass filter comprising:
forming an disk resonator and input and output signal lines over a dielectric base substrate, the input and the output signal lines extending at substantially 90 degrees from each other with respect to the disk resonator; and
disposing a dielectric block at a position other than a position that is opposite to the input port and the output port with respect to a center of the disk resonator and that is on an extended line passing though the center of the disk resonator and the input port or on an extended line passing though the center of the disk resonator and the output port, the dielectric block having a size to cover a part of the dielectric base substrate.
